(19) United States
(12) Patent Application Publication
(10) Pub. No.: US 2013/0022789 A1
(43) Pub. Date: Jan. 24, 2013

(54) GRAVURE PRINTING PLATE AND METHOD FOR PRODUCING GRAVURE PRINTING PLATE

(71) Applicant: Tatsuo Shigeta, Chiba (JP)

(72) Inventor: Tatsuo Shigeta, Chiba (JP)

(21) Appl. No.: 13/639,036

(22) PCT Filed: Jul. 14, 2011
(86) PCT No.: PCT/JP2011/066037

§ 371 Date: Oct. 2, 2012

(30) Foreign Application Priority Data
Aug. 5, 2010 (JP) 2010-176307

(51) Int. Cl. B41N 1/00; B32B 3/30; B41M 1/10; B41C 3/00

(52) U.S. Cl. 428/156; 101/395; 101/401.1

(57) ABSTRACT

Provided are a gravure printing plate and a method of manufacturing a gravure printing plate, which are capable of increasing a density range as compared to the conventional case to enable suppression of moire as well as to achieve rich gradation and enable fine tone settings. The gravure printing plate includes FM screen cells and AM screen cells which are concurrently formed in a plate surface thereof, and the FM screen cells and the AM screen cells are different in depth. It is preferred that, of the cells which are different in depth, shallower cells correspond to subcells and deeper cells correspond to main cells.

### TECHNICAL FIELD

The present invention relates to a gravure printing plate and a method of manufacturing a gravure printing plate, which are capable of increasing a density range as compared to a conventional case to enable fine tone settings.

### BACKGROUND ART

Cells of gravure plates are formed by a method involving an engraving process or a method involving photosensitive film application, exposure, development, and etching (etching process). In the method of forming cells by the engraving process, the cells are each formed into a quadrangular pyramid shape, and hence ink is transferred satisfactorily in a highlight part. In the etching process, the cells are each formed as a depression having a shallow dish shape, and hence ink may be clogged in the cells in a highlight part where the cells are extremely small. For this reason, the etching process is inferior to the engraving process in terms of the ink transfer. However, in the etching process, the cells are formed so as to enable ink flow at intersections of screen lines in the most shadowy part, and hence the etching process has advantages in that the ink may be transferred reliably at the intersections and each character has an outline without serration. Further, the cells in the most shadowy part are also shallow, and hence the etching process is suitable for printing which uses water-based ink.

To solve the problem of unsatisfactory ink transfer or the like, the applicant of the present invention has proposed a gravure printing plate manufactured based on print information obtained by superimposing FM screen information, which is obtained through FM screening of information before the manufacture of the plate corresponding to a region ranging from the highlight part to the shadowy part, and AM screen information, which is obtained through AM screening of the information before the manufacture of the plate corresponding to a region of the shadowy part or a region ranging from a portion of the halftone part, which is close to the shadowy part, to the shadowy part, and is displayed as screen lines of an AM screen in the most shadowy part, in which the FM screen is generated in a region ranging from the highlight part to the halftone part and smallest cells thereof are restricted to have a size required to enable satisfactory ink transfer, and in which the AM screen formed in matrix is gradually generated in a region from the halftone part and completely occupies a region of the shadowy part (Patent Document 1).

In recent years, printing of higher resolution has further been demanded, and along with this demand, there is another demand for a further increase in density range to perform fine tone settings.

### PRIOR ART DOCUMENTS

### Patent Documents

Patent Document 1: JP 2004-243609 A

### SUMMARY OF THE INVENTION

### Problem to be Solved by the Invention

The inventor of the present invention has pursued extensive studies and eventually found that the density range can further be increased and therefore fine tone settings can be performed by combining the FM screen cells with the AM screen cells and varying the depths thereof. Thus, the present invention has been attained.

The present invention has been made in view of the above-mentioned problem inherent in the conventional technology, and it is therefore an object thereof to provide a gravure printing plate and a method of manufacturing a gravure printing plate, which are capable of increasing a density range as compared to the conventional case to enable suppression of moire as well as to achieve rich gradation and enable fine tone settings.

### Means for Solving Problem

In order to solve the above-mentioned problem, the gravure printing plate according to the present invention is a gravure printing plate including FM screen cells and AM screen cells which are concurrently formed in a plate surface thereof, in which the FM screen cells and the AM screen cells are different in depth.

Further, it is preferred that of the FM screen cells and the AM screen cells which are different in depth, shallower cells are subcells and deeper cells are main cells. That is, the FM screen cells may be the subcells which are smaller in depth, and the AM screen cells may be the main cells which are larger in depth. Alternatively, the AM screen cells may be the subcells which are smaller in depth, and the FM screen cells may be the main cells which are larger in depth.

Further, it is preferred that a surface area of each of the main cells is larger than a surface area of each of the subcells. That is, it is preferred that the main cells be larger in depth and surface area, and the subcells be smaller in depth and surface area, by which the density range can be increased.

It is preferred that the FM screen cells correspond to the subcells, and the AM screen cells correspond to the main cells.

Further, it is preferred that each of the FM screen cells has a depth of 2 μm to 10 μm, and each of the AM screen cells has a depth of 11 μm to 30 μm.

The method of manufacturing a gravure printing plate according to the present invention is a method of manufacturing a gravure printing plate including FM screen cells and AM screen cells which are concurrently formed in a plate surface thereof, the method including forming the FM screen cells and the AM screen cells at different depths.

It is preferred that of the FM screen cells and the AM screen cells which are different in depth, shallower cells are subcells, and deeper cells are main cells. That is, the FM screen cells may be the subcells which are smaller in depth, and the AM screen cells may be the main cells which are larger in depth. Alternatively, the AM screen cells may be the subcells which are smaller in depth, and the FM screen cells may be the main cells which are larger in depth.

Further, it is preferred that the main cells be larger in surface area than the subcells.

It is preferred that the FM screen cells correspond to the subcells, and the AM screen cells correspond to the main cells.

It is preferred that the method of manufacturing a gravure printing plate further includes: a subcell forming step of forming the subcells through resist application, exposure, development, corrosion, and resist removal; and a main cell forming step of forming the main cells through resist application, exposure, development, corrosion, and resist removal.

The subcell forming step may precede the main cell forming step, or alternatively, the main cell forming step may precede the subcell forming step. However, from the viewpoint of workability, the subcell forming step is preferred to precede the main cell forming step.

Further, it is preferred that each of the FM screen cells has a depth of 2 μm to 10 μm, and each of the AM screen cells has a depth of 11 μm to 30 μm.

Further, it is preferred that a reinforcement film layer be provided to the cells, and that the reinforcement coating layer be a DLC layer, a chromium-plated layer, or a silicon dioxide film.

A product according to the present invention is obtained through printing with use of the above-mentioned gravure plate.

### Effect of the Invention

The present invention has a significant effect in that it is possible to provide a gravure printing plate and a method of manufacturing a gravure printing plate, which are capable of increasing a density range as compared to the conventional case to enable suppression of moire as well as to achieve rich gradation and enable fine tone settings.

### BRIEF DESCRIPTION OF DRAWINGS

FIG. 1 is an electron micrograph showing a plate surface including AM screen cells in the ratio of 10% and FM screen cells in the ratio of 1%.

FIG. 2 is an electron micrograph showing a plate surface including AM screen cells in the ratio of 10% and FM screen cells in the ratio of 10%.

FIG. 3 is an electron micrograph showing a plate surface including AM screen cells in the ratio of 20% and FM screen cells in the ratio of 10%.

FIG. 4 is a set of optical interference micrographs showing plate surfaces of a gravure plate of Example 4.

FIG. 5 is a photograph showing a state of printing performed on a corrugated cardboard surface with use of the gravure plate of Example 4.

FIG. 6 is an electron micrograph showing a plate surface including AM screen cells in the ratio of 0% and FM screen cells in the ratio of 1%.

FIG. 7 is an electron micrograph showing a plate surface including AM screen cells in the ratio of 0% and FM screen cells in the ratio of 10%.

FIG. 8 is a set of optical interference micrographs showing plate surfaces of a gravure plate of Comparative Example 3.

FIG. 9 is a photograph showing a state of printing performed on a corrugated cardboard surface with use of the gravure plate of Comparative Example 3.

### BEST MODES FOR CARRYING OUT THE INVENTION

Embodiments of the present invention are described below. Those embodiments are described as examples, and it is therefore understood that various modifications may be made thereto without departing from the technical spirit of the present invention.

The gravure printing plate according to the present invention is a gravure printing plate including FM screen cells and AM screen cells which are concurrently formed in a plate surface thereof, in which the FM screen cells and the AM screen cells are different in depth.

Thus, the FM screen cells and the AM screen cells are combined with each other at different depths so that the density range is increased as compared to the conventional case. As a result, rich gradation can be achieved and fine tone settings can be performed. In the conventional case, the AM screen cells have been formed at a gray scale of 10%, 20%, 30% . . . 100%, but a delicate setting for a gray scale of, for example, 19% has been difficult. However, in the present invention, the FM screen cells and the AM screen cells are not merely combined with each other but combined at different depths. As a result, fine tone settings which have conventionally been difficult can be performed.

In the conventional case, there has been a problem in that moire may occur in the AM screen. In the present invention, the moire can be suppressed. Further, in the conventional case, small cells have been arranged randomly in the FM screen, and hence dots are liable to be sparse particularly in a highlight part and a problem arises in stabilization of quality. In the present invention, the AM screen is combined, and hence such problems inherent in the FM screen can be solved.

Further, the total volume of the cells can be reduced, and hence an amount of ink can be reduced. As a result, a usage amount of volatile organic compounds (VOC) and an amount of CO₂ emission can be reduced. Further, there is an advantage in that the moire can be suppressed at the time of printing.

It is preferred that, of the cells which are different in depth, shallower cells correspond to subcells and deeper cells correspond to main cells, and that the main cells be larger in surface area than the subcells. It is preferred that the FM screen cells correspond to the subcells and the AM screen cells correspond to the main cells.

Further, it is preferred that each of the FM screen cells has a depth of 2 μm to 10 μm, and each of the AM screen cells has a depth of 11 μm to 30 μm.

It is preferred that the gravure printing plate according to the present invention include a plate base material, a cell forming layer provided on the plate base material, and a reinforcement coating layer provided so as to coat a surface of the cell forming layer. Further, the gravure printing plate according to the present invention may be any one of a flat plate and a cylindrical plate.

It is preferred that the cell forming layer be a copper-plated layer, and the reinforcement coating layer be a DLC layer, a chromium-plated layer, or a silicon dioxide film.

The method of manufacturing a gravure printing plate according to the present invention is a method of manufacturing a gravure printing plate including FM screen cells and AM screen cells which are concurrently formed in a plate surface thereof, the method including forming the FM screen cells and the AM screen cells at different depths.

It is preferred that, of the cells which are different in depth, shallower cells correspond to subcells and deeper cells correspond to main cells, and that the main cells be larger in surface area than the subcells. That is, the FM screen cells may be set as the subcells which are smaller in depth, and the AM screen cells may be set as the main cells which are larger in depth. Alternatively, the AM screen cells may be set as the subcells which are smaller in depth, and the FM screen cells may be set as the main cells which are larger in depth.

Further, it is preferred that the main cells be larger in surface area than the subcells.

It is preferred that the FM screen cells correspond to the subcells, and the AM screen cells correspond to the main cells.

It is preferred that the method of manufacturing a gravure printing plate further includes: a subcell forming step of forming the subcells through resist application, exposure, development, corrosion, and resist removal; and a main cell forming step of forming the main cells through resist application, exposure, development, corrosion, and resist removal.

The main cell forming step may be conducted after the subcell forming step, or alternatively, the subcell forming step may be conducted after the main cell forming step. However, from the viewpoint of workability, the main cell forming step is preferably conducted after the subcell forming step.

Further, it is preferred that each of the FM screen cells has a depth of 2 μm to 10 μm, and each of the AM screen cells has a depth of 11 μm to 30 μm.

### EXAMPLES

The present invention is described below in further detail by way of examples. However, it is needless to say that those examples are given for an illustrative purpose and should not be construed as a limitation.

### Example 1

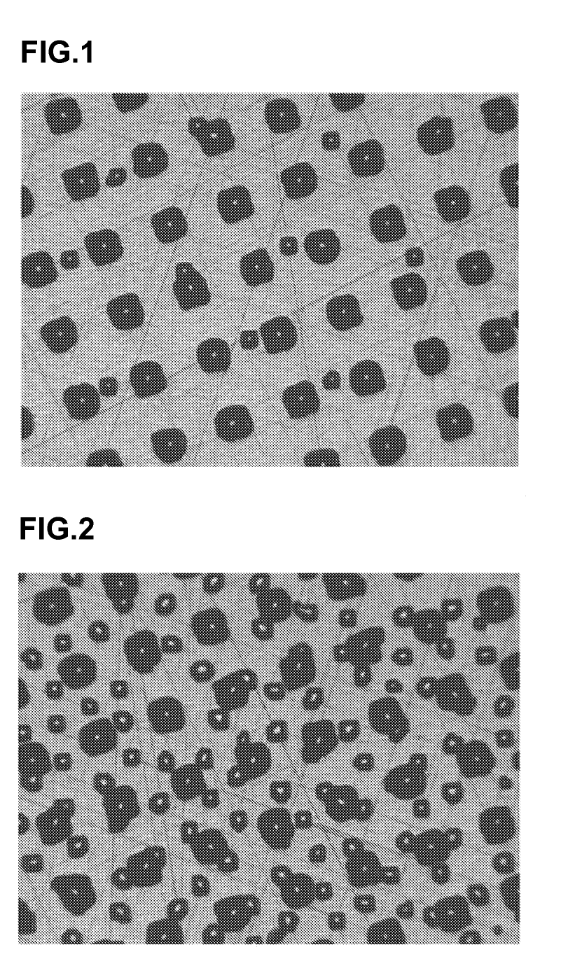

Laser platemaking was performed with use of a laser gravure platemaking apparatus manufactured by THINK LABORATORY Co., Ltd. (product name: fully automatic laser gravure platemaking system FX80) to manufacture a gravure plate in which FM screen cells formed in the ratio of 1% and at the depth of 3 μm were set as subcells, and AM screen cells formed in the ratio of 10% and at the depth of 15 μm were set as main cells. The main cells and the subcells were positionally aligned at the time of exposure. FIG. 1 shows a plate surface of the gravure plate thus manufactured. In the plate surface of FIG. 1, cells having a larger size are the AM screen cells, and cells having a smaller size are the FM screen cells. When printing was performed with use of the gravure plate thus manufactured, the printed product exhibited slightly higher tone values than in a case of using a plate including only AM screen cells in the ratio of 10%, and the range of gradation was increased. Moire was not observed.

### Example 2

Similarly to Example 1, a gravure plate was manufactured, in which FM screen cells formed in the ratio of 10% and at the depth of 3 μm were set as subcells, and AM screen cells formed in the ratio of 10% and at the depth of 15 μm were set as main cells. FIG. 2 shows a plate surface of the gravure plate thus manufactured. In the plate surface of FIG. 2, cells having a larger size are the AM screen cells, and cells having a smaller size are the FM screen cells. When printing was performed with use of the gravure plate thus manufactured, the printed product exhibited slightly higher tone values than in the case of using the gravure plate of Example 1, and the range of gradation was increased. Moire was not observed.

### Example 3

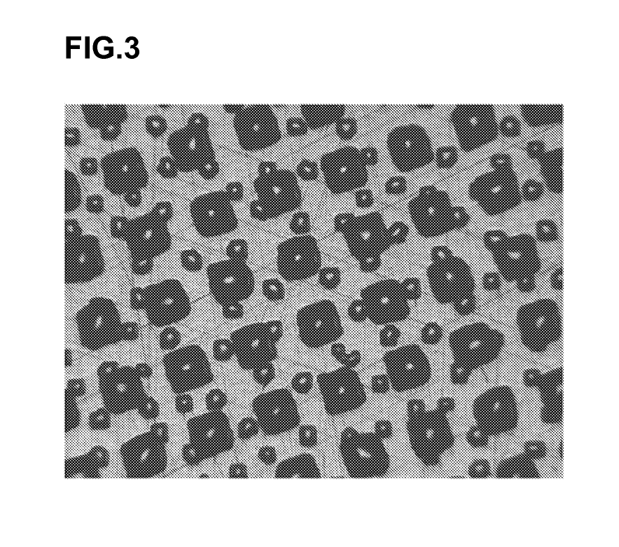

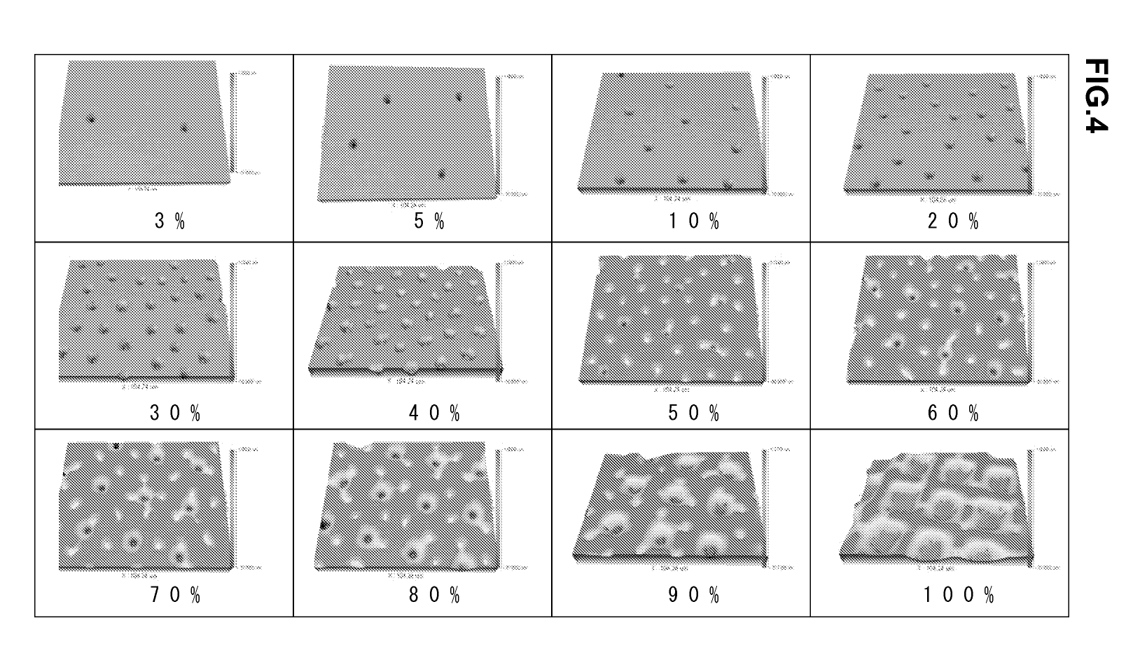

Similarly to Example 1, a gravure plate was manufactured, in which FM screen cells formed in the ratio of 10% and at the depth of 3 μm were set as subcells, and AM screen cells formed in the ratio of 20% and at the depth of 15 μm were set as main cells. FIG. 3 shows a plate surface of the gravure plate thus manufactured. In the plate surface of FIG. 3, cells having a larger size are the AM screen cells, and cells having a smaller size are the FM screen cells. When printing was performed with use of the gravure plate thus manufactured, the printed product exhibited slightly higher tone values than in a case of using a plate including only AM screen cells in the ratio of 20%, and the range of gradation was increased. Moire was not observed.

### Example 4

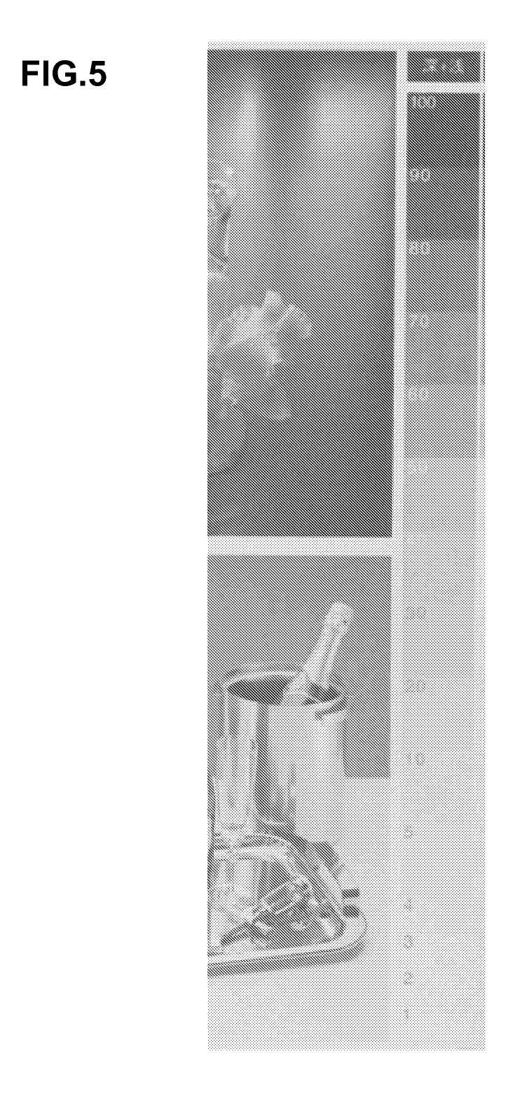

Laser platemaking was performed with use of the laser gravure platemaking apparatus manufactured by THINK LABORATORY Co., Ltd. (product name: fully automatic laser gravure platemaking system FX80) to manufacture a gravure plate including 3% dots, 5% dots, 10% dots, 20% dots, 30% dots, 40% dots, 50% dots, 60% dots, 70% dots, 80% dots, 90% dots, and 100% dots by combining subcells corresponding to FM screen cells formed at a depth of 4 μm with main cells corresponding to AM screen cells formed at a depth of 20 μm. At this time, the FM screen cells were used for the 3% dots, the 5% dots, the 10% dots, the 20% dots, the 30% dots, and the 40% dots, and the FM screen cells and the AM screen cells were used for the 50% dots, the 60% dots, the 70% dots, the 80% dots, the 90% dots, and the 100% dots. The number of lines of the AM screen cells per inch was 175. FIG. 4 is a set of optical interference micrographs showing plate surfaces of the gravure plate thus manufactured. In FIG. 4, the scale of each micrograph in the X-axis direction (horizontal axis direction) is 104.24 μm, and the scale of each micrograph in the Y-axis direction (vertical axis direction) is 78.43 μm. In the plate surfaces of FIG. 4, cells having a larger size are the AM screen cells, and cells having a smaller size are the FM screen cells. When printing was performed on a corrugated cardboard surface with use of the gravure plate thus manufactured, rich gradation was obtained as shown in FIG. 5. Moire was not observed.

As described above, in the examples, even in the case of printing performed on a corrugated cardboard surface that was poorly appropriate for printing, the density range was increased as compared to the conventional case so that rich gradation was achieved and fine tone settings were performed. Further, moire was suppressed.

### Comparative Example 1

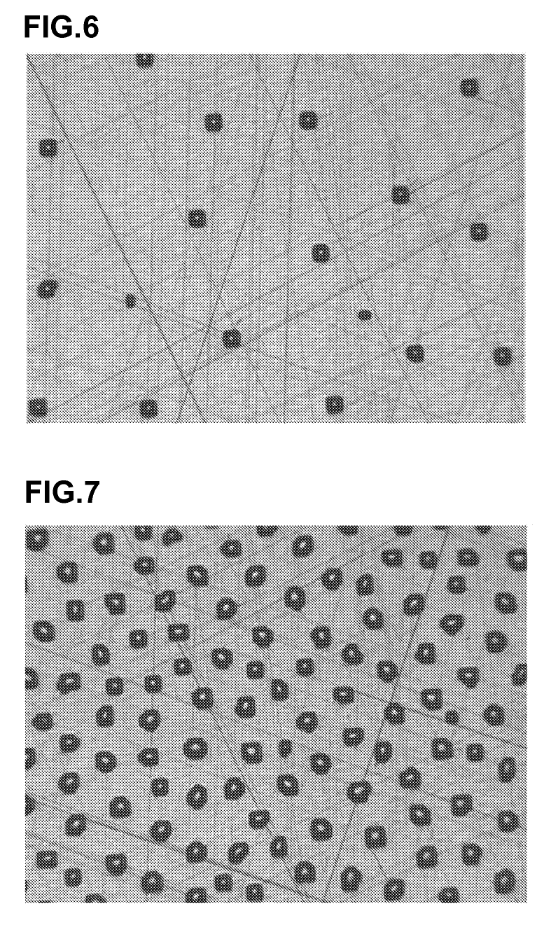

Laser platemaking was performed with use of the laser gravure platemaking apparatus manufactured by THINK LABORATORY Co., Ltd. (product name: fully automatic laser gravure platemaking system FX80) to manufacture a gravure plate in which FM screen cells were provided in the ratio of 1% and at the depth of 3 μm. FIG. 6 shows a plate surface of the gravure plate thus manufactured. When printing was performed with use of the gravure plate thus manufactured, moire was not observed, but dots seemed sparse, resulting in rough appearance of the printed product.

### Comparative Example 2

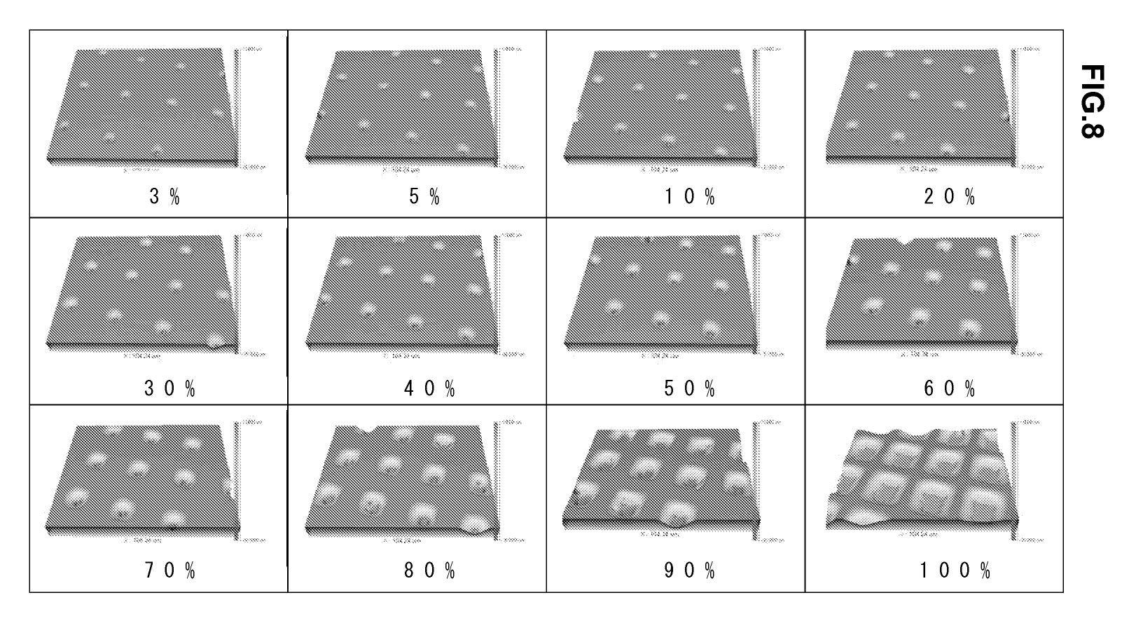

Similarly to Comparative Example 1, a gravure plate was manufactured, in which FM screen cells were provided in the ratio of 10% and at the depth of 3 μm. FIG. 7 shows a plate surface of the gravure plate thus manufactured. When printing was performed with use of the gravure plate thus manufactured, moire was not observed, but dots seemed sparse, resulting in rough appearance of the printed product.

### Comparative Example 3

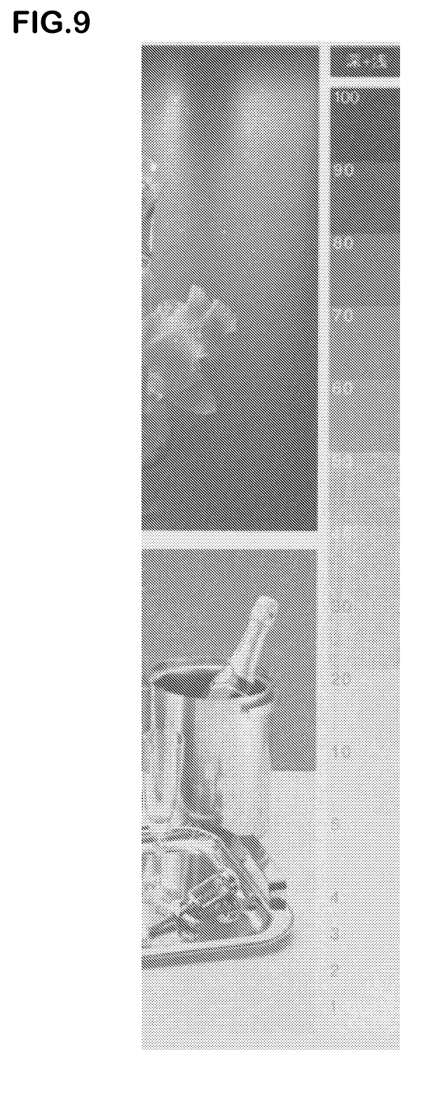

Laser platemaking was performed with use of the laser gravure platemaking apparatus manufactured by THINK LABORATORY Co., Ltd. (product name: fully automatic laser gravure platemaking system FX80) to manufacture a gravure plate including 3% dots, 5% dots, 10% dots, 20% dots, 30% dots, 40% dots, 50% dots, 60% dots, 70% dots, 80% dots, 90% dots, and 100% dots by using only AM screen cells formed at a depth of 20 μm. The number of lines per inch was 200. FIG. 8 is a set of optical interference micrographs showing plate surfaces of the gravure plate thus manufactured. In FIG. 8, the scale of each micrograph in the X-axis direction (horizontal axis direction) is 104.24 μm, and the scale of each micrograph in the Y-axis direction (vertical axis direction) is 78.43 μm. When printing was performed on a corrugated cardboard surface with use of the gravure plate thus manufactured, gradation as shown in FIG. 9 was obtained, and this gradation was not as rich as those in the above-mentioned examples. Further, moire was observed in some degree.

1. A gravure printing plate, comprising:
FM screen cells and AM screen cells which are concurrently formed in a plate surface thereof, wherein the FM screen cells and the AM screen cells are different in depth.

2. A gravure printing plate according to claim 1, wherein of the FM screen cells and the AM screen cells which are different in depth, shallower cells are subcells and deeper cells are main cells, and a surface area of each of the main cells is larger than a surface area of each of the subcells.

3. A gravure printing plate according to claim 2, wherein the surface area of said main cells is larger than the surface area of the subcells.

4. A gravure printing plate according to claim 2, wherein the FM screen cells correspond to the subcells, and the AM screen cells correspond to the main cells.

5. A gravure printing plate according to claim 1, wherein each of the FM screen cells has a depth of 2 μm to 10 μm, and each of the AM screen cells has a depth of 11 μm to 30 μm.

6. A method of manufacturing a gravure printing plate, comprising:
providing FM screen cells and AM screen cells which are concurrently formed in a plate surface thereof, wherein the FM screen cells and the AM screen cells are formed at different depths.

7. A method of manufacturing a gravure printing plate according to claim 6, wherein of the FM screen cells and the AM screen cells which are different in depth, shallower cells are subcells, and deeper cells are main cells, and a surface area of each of the main cells is larger than a surface area of each of the subcells.

8. A method of manufacturing a gravure printing plate according to claim 7, wherein the FM screen cells are the subcells, and the AM screen cells are the main cells.

9. A method of manufacturing a gravure printing plate according to claim 7, further comprising:
a subcell forming step of forming the subcells through resist application, exposure, development, corrosion, and resist removal; and
a main cell forming step of forming the main cells through resist application, exposure, development, corrosion, and resist removal.

10. A method of manufacturing a gravure printing plate according to claim 6, wherein each of the FM screen cells has a depth of 2 μm to 10 μm, and each of the AM screen cells has a depth of 11 μm to 30 μm.

11. A product, which is obtained through printing with use of a gravure printing plate, said gravure printing plate comprising FM screen cells and AM screen cells which are concurrently formed in a plate surface thereof, wherein the FM screen cells and the AM screen cells are different in depth.
